(19) United States
(12) Patent Application Publication
(10) Pub. No.: US 2023/0378522 A1
(43) Pub. Date: Nov. 23, 2023

(54) INTERFACE LAYER OF LITHIUM METAL ANODE AND SOLID ELECTROLYTE AND PREPARATION METHOD THEREOF

(71) Applicant: YANGTZE DELTA REGION INSTITUTE OF UNIVERSITY OF ELECTRONIC SCIENCE AND TECHNOLOGY OF CHINA, HUZHOU, Huzhou (CN)

(72) Inventors: Ziqiang XU, Chengdu (CN); Mengqiang WU, Chengdu (CN); Zixuan FANG, Chengdu (CN); Yarong ZHANG, Chengdu (CN)

(21) Appl. No.: 17/988,992

(22) Filed: Nov. 17, 2022

(30) Foreign Application Priority Data
May 18, 2022 (CN) CN202210542140.6

(51) Int. Cl. H01M 10/0562

(52) U.S. Cl. CPC H01M 10/0562; H01M 2300/0068

(57) ABSTRACT

Disclosed are an interface layer of metallic lithium and solid electrolyte and preparation method thereof, including dissolving polymer matrix and lithium salt in an organic solvent, then adding a mixed powder of boron nitride nanoparticles and solid electrolyte, dispersing evenly, coating onto a solid electrolyte, and drying to obtain an interface layer.

### CROSS-REFERENCE TO RELATED APPLICATIONS

This application claims priority to Chinese Patent Application No. 202210542140.6, filed on May 18, 2022, the contents of which are hereby incorporated by reference.

### TECHNICAL FIELD

The present application belongs to the technical field of lithium-ion batteries, and particularly relates to a preparation method of lithium metal/solid electrolyte interface layer containing boron nitride additive and application thereof.

### BACKGROUND

Lithium-ion batteries, with high energy density and long service life, have been gaining attention in recent years among various commercial rechargeable/dischargeable chemical energy storage devices, and have been widely used in cell phones, laptops, electric vehicles and other fields since their introduction into the market. Yet, the development of electric vehicles and large-scale energy storage systems raises the demand for chemical energy storage technologies with high energy density and high safety. Currently, lithium-ion batteries have the disadvantage of insufficient theoretical energy density, in addition to safety risk of leakage, combustion and even explosion due to the flammability and narrow electrochemical stability window of organic electrolytes; while the safety problems of all-solid-state batteries can be fundamentally solved by using solid electrolyte instead of organic electrolyte; solid electrolyte, as a key material for preparing all-solid-state lithium batteries, can effectively improve the safety and stability of batteries thanks to its high mechanical strength, excellent density and ability to resist the growth of lithium dendrites.

However, the problems at the interface of solid electrolyte and electrode greatly limit the development of solid-state batteries; on the one hand, the interface impedance of all-solid-state battery is very high due to the poor contact of solid-solid interface between solid electrolyte and electrode, which seriously affects the ion transport at the interface; on the other hand, NASCION-type solid-state electrolytes of Li_{1.3}Al_{0.3}Ti_{1.7}(PO₄)₃ (LATP) and LAGP, Li_{0.5}La_{0.5}TiO₃ and some sulfide electrolytes are unstable to lithium metal although having high ionic conductivity, which will limit the application of lithium metal in these solid electrolyte-based solid-state batteries.

Such problems can be effectively solved by adding a proper interface layer between the solid electrolyte and the electrode. therefore, it is necessary to develop an interface functional layer that can not only improve the contact between the solid electrolyte and the lithium metal anode, but also effectively improve the stability of the solid electrolyte to the lithium metal anode.

### SUMMARY

The present application provides an interface layer of lithium metal and solid electrolyte containing boron nitride and preparation method thereof, where the prepared interface layer has good adhesion, high ionic conductivity and stability to metallic lithium, and be utilized to effectively improve the contact problem and electrical/chemical stability between solid electrolyte and metallic lithium cathode.

In order to achieve the above objectives, the present application adopts technical schemes as follows:
a preparation method of lithium metal and solid electrolyte interface layer, including forming an interface layer on a surface of inorganic solid electrolyte so as to improve the solid electrolyte and cathode of lithium metal in terms of compatibility, and the method includes:
S1, dissolving a polymer matrix in an organic solvent, adding lithium salt and stirring to fully dissolve the lithium salt to obtain a mixed liquid;
S2, ball-milling boron nitride nanoparticles and solid electrolyte powder to obtain a mixed powder, calcining the mixed powder, then uniformly grinding the calcined mixed powder and adding it into the mixed liquid obtained in S1, and fully mixing and stirring after ultrasonic dispersion to obtain an interface layer dispersion liquid; and
S3, coating that interface layer dispersion liquid obtained in S2 onto a surface of the solid electrolyte, and obtaining an interface layer on the surface of the solid electrolyte after drying.

In a preferred embodiment, the organic solvent in S1 is one selected from a group of tetrahydrofuran, propylene carbonate, methyl ethyl carbonate, diethyl carbonate, acetonitrile, acetone, dimethyl sulfoxide, malononitrile, glutaronitrile and N,N-dimethylformamide (DMF).

In a preferred embodiment, the polymer matrix in S1 is one selected from a group of polyethylene oxide (PEO), polyvinyl alcohol (PVA), polymethyl methacrylate, polyacrylonitrile and polyvinylidene fluoride; and/or the polymer matrix accounts for 40-93 percent (%) of a total mass of the interface layer.

In a preferred embodiment, the lithium salt in S1 is one or more selected form a group of lithium bis(trifluoromethanesulphonyl)imide (LiTFSI), lithium bis(fluorosulfonyl)imide (LiFSI), lithium perchlorate (LiClO₄), lithium Hexafluorophosphate (LiPF₆), lithium Tetrafluoroborate (LiBF₄), LiBOB, lithium bis(oxalate)borate (LiDFOB) and lithium difluorophosphate (LiPF₂O₂); and the lithium salt accounts for 5-20% of the total mass of the interface layer.

In a preferred embodiment, the boron nitride nanoparticles in S2 have a particle size of <300 nanometers (nm), preferably <150 nm; and/or the boron nitride nanoparticles account for 1-20% of the total mass of the interface layer.

In a preferred embodiment, the solid electrolyte powder in S2 is one solid electrolyte of garnet type, perovskite type or NASICON type;

and/or, the solid electrolyte powder has a particle size of 1 microns (um)-10 um, preferably 1 um-5 um, more preferably 1-2 um;

and/or, the solid electrolyte powder accounts for 1-20% of the total mass of the interface layer.

In a preferred embodiment, calcining the mixed powder is performed at 400-1,000 degree Celsius (° C.) in S2, preferably at 600-800° C.

In a preferred embodiment, the interface layer dispersion liquid in S2 is subjected to vacuum defoaming treatment before coating.

In a preferred embodiment, the solid electrolyte used as a coating substrate in S3 is a solid electrolyte to be modified, which is one of garnet type, perovskite type or NASICON type solid electrolytes.

The present application also provides an interface layer of metallic lithium and solid electrolyte obtained by the preparation method.

The preparation method of the interface layer is simple, easy to operate, and convenient for industrial production, whereby an interface functional layer is arranged between the lithium metal anode and the solid electrolyte so as to improve the contact problem between the lithium metal anode and the solid electrolyte, thus inhibiting the uneven deposition of lithium ions in the interface gap and reducing the interface impedance; moreover, the interface functional layer is added with boron nitride nanoparticles, which have good chemical stability and further improves the stability of solid electrolyte to metallic lithium.

As comparing to the prior art, the present application has the beneficial effect that:

The solid electrolyte is coated with the interface layer composed of polymer, lithium salt, boron nitride nanoparticles and mixed powder of solid electrolyte on the surface, where the interface layer has good ionic conductivity and allows lithium ions to selectively pass through; further, boron nitride is added not only to improve the uniform thermal environment at the interface with its good thermal conductivity, promoting the uniform deposition of lithium ions, but also improve the stability of lithium with its strong hardness and high stability.

### BRIEF DESCRIPTION OF THE DRAWINGS

FIG. 1 is a structural schematic of a lithium symmetric cell including an interface layer of the present application.

FIG. 2 illustrates electrochemical impedance under room temperature of an interface layer prepared in Embodiment 2.

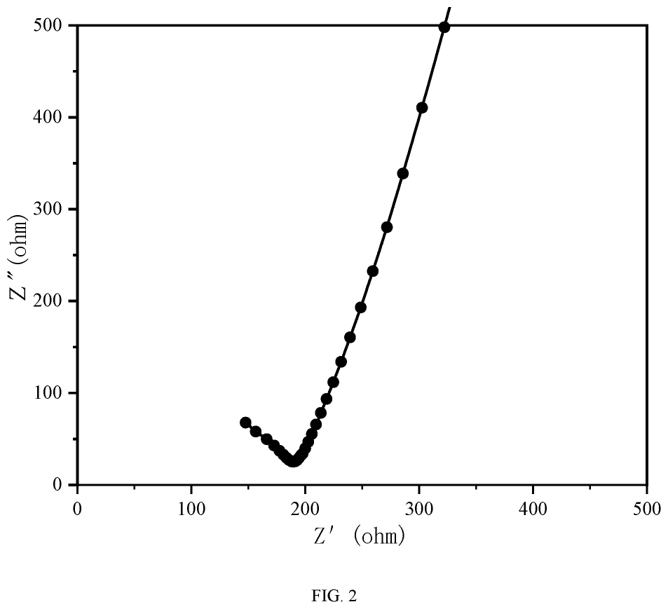

FIG. 3 shows a cycling diagram of a lithium symmetric cell containing the interface layer prepared in Embodiment 2 at a current density of 0.1 milliampere per square centimeter (mA/cm²).

FIG. 4 shows a processing of a preparation method of lithium metal and solid electrolyte interface layer provided by the present application.

### DETAILED DESCRIPTION OF THE EMBODIMENTS

The following embodiments of the present application are illustrated by specific concrete embodiments, and other advantages and effects of the present application can be readily understood by those skilled in the art as disclosed herein. The present application may also be implemented or applied by different specific embodiments, and the details in this specification may be modified or changed in various ways based on different views and applications without departing from the spirit of the present application.

The present application adopts a basic idea as follows: an interface layer is coated onto a surface of a solid electrolyte, where the interface layer is prepared by coating an inorganic solid electrolyte with an interface layer dispersion obtained by dispersing a mixed powder of polymer, lithium salt, boron nitride nanoparticles and solid electrolyte in an organic solvent and then drying.

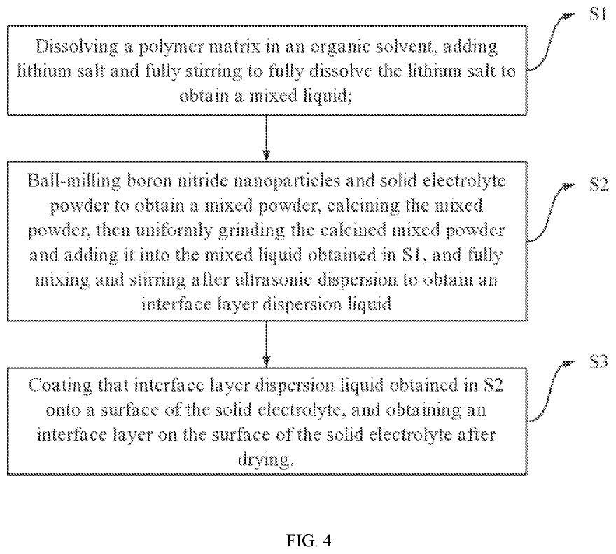

With reference to FIG. 4, the present application provides a preparation method of lithium metal and solid electrolyte interface layer, including forming an interface layer on a surface of inorganic solid electrolyte so as to improve the solid electrolyte and cathode of lithium metal in terms of compatibility, including:

S1, dissolving a polymer matrix in an organic solvent, adding lithium salt and fully stirring to fully dissolve the lithium salt to obtain a mixed liquid;

S2, ball-milling boron nitride nanoparticles and solid electrolyte powder to obtain a mixed powder, calcining the mixed powder, then uniformly grinding the calcined mixed powder and adding it into the mixed liquid obtained in S1, and fully mixing and stirring after ultrasonic dispersion to obtain an interface layer dispersion liquid; and

S3, coating that interface layer dispersion liquid obtained in S2 onto a surface of the solid electrolyte, and obtaining an interface layer on the surface of the solid electrolyte after drying.

In a preferred embodiment, the organic solvent in S1 is one selected from a group of tetrahydrofuran, propylene carbonate, methyl ethyl carbonate, diethyl carbonate, acetonitrile, acetone, dimethyl sulfoxide, malononitrile, glutaronitrile and N,N-dimethylformamide (DMF).

In a preferred embodiment, the polymer matrix in S1 is one selected from a group of polyethylene oxide (PEO), polyvinyl alcohol (PVA), polymethyl methacrylate, polyacrylonitrile and polyvinylidene fluoride; and/or the polymer matrix accounts for 40-93 percent (%) of a total mass of the interface layer.

In a preferred embodiment, the lithium salt in S1 is one or more selected form a group of lithium bis(trifluoromethanesulphonyl)imide (LiTFSI), lithium bis(fluorosulfonyl)imide (LiFSI), lithium perchlorate (LiClO₄), lithium Hexafluorophosphate (LiPF₆), lithium Tetrafluoroborate (LiBF₄), LiBOB, lithium bis(oxalate)borate (LiDFOB) and lithium difluorophosphate (LiPF₂O₂); and the lithium salt accounts for 5-20% of the total mass of the interface layer.

In a preferred embodiment, the boron nitride nanoparticles in S2 have a particle size of <300 nanometers (nm), preferably <150 nm; and/or the boron nitride nanoparticles account for 1-20% of the total mass of the interface layer.

In a preferred embodiment, the solid electrolyte powder in S2 is one solid electrolyte of garnet type, perovskite type or NASICON type;
and/or, the solid electrolyte powder has a particle size of 1 microns (um)-10 um, preferably 1 um-5 um, more preferably 1-2 um;
and/or, the solid electrolyte powder accounts for 1-20% of the total mass of the interface layer.

In a preferred embodiment, calcining the mixed powder in S2 is performed at 400-1,000 degree Celsius (° C.), preferably at 600-800° C.

In a preferred embodiment, the interface layer dispersion liquid in S2 is subjected to vacuum defoaming treatment before coating.

In a preferred embodiment, the solid electrolyte used as a coating substrate in S3 is a solid electrolyte to be modified, which is one of garnet type, perovskite type or NASICON type solid electrolytes.

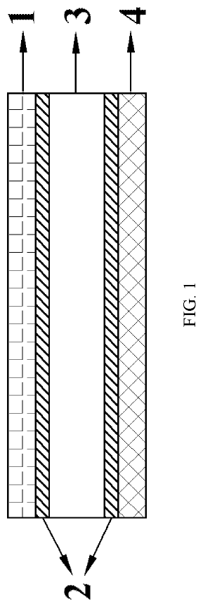

The present application also provides an interface layer of metallic lithium and solid electrolyte obtained by the preparation method, as shown in FIG. 1.

Specific embodiments of the present application are further described hereinafter in connection with embodiments. The raw materials described can be obtained from open commercial sources if not otherwise specified.

### Embodiment 1

S1, dissolving polyoxyethylene (70 weight percentage, wt %) and LiTFSI (10 wt %) in acetonitrile in an atmosphere filled with argon, and continuously stirring overnight to obtain a uniformly mixed liquid A;

S2, weighing solid electrolyte powder Li_{1.3}Al_{0.3}Ti_{1.7}(PO₄)₃ (LATP, 800 nm-2 um) and boron nitride nanoparticles (<150 nm) according to a mass ratio of 4:1 and mixing them evenly, followed by calcining at 600° C. for 2 hours (h) after high-energy ball-milling to obtain a mixed powder B; grinding the mixed powder B (20 wt %) and adding it into the mixed liquid A, then continuously mixing and fully stirring after ultrasonic dispersion for 40 minutes (min) to obtain an interface layer dispersion liquid; and

S3, coating that interface layer dispersion liquid obtained in S2 onto a surface of a LATP ceramic sheet, followed by vacuum drying at 40° C. for 1 h, drying in a blast oven at 80° C. for 6 h, and drying in a vacuum oven at 60° C. for 2 h, then obtaining an interface layer supported by the LATP ceramic sheet.

### Embodiment 2

S1, dissolving polyoxyethylene (40 wt %) and LiTFSI (20 wt %) in acetone in an atmosphere filled with argon, and continuously stirring overnight to obtain a uniformly mixed liquid A;

S2, weighing solid electrolyte powder LATP (800 nm-2 um) and boron nitride nanoparticles (<150 nm) according to a mass ratio of 2:1 and mixing them evenly, followed by calcining at 800° C. for 2 h after high-energy ball-milling to obtain a mixed powder B; grinding the mixed powder B (40 wt %) and adding it into the mixed liquid A, then continuously mixing and fully stirring after ultrasonic dispersion for 40 min to obtain an interface layer dispersion liquid; and

S3, coating that interface layer dispersion liquid obtained in S2 of the present embodiment onto a surface of a LATP ceramic sheet, followed by vacuum drying at 60° C. for 1 h, drying in a blast oven at 100° C. for 6 h, and drying in a vacuum oven at 80° C. for 2 h, then obtaining an interface layer supported by the LATP ceramic sheet.

The results of electrochemical impedance under room temperature of the interface layer prepared is shown in the above Embodiment 2, form where it can be seen that the interface layer is sandwiched by two stainless steel sheets, and the interface layer has a high ionic conductivity of 2.76×10⁻⁴ Siemens per centimeter (S·cm⁻¹) under room temperature.

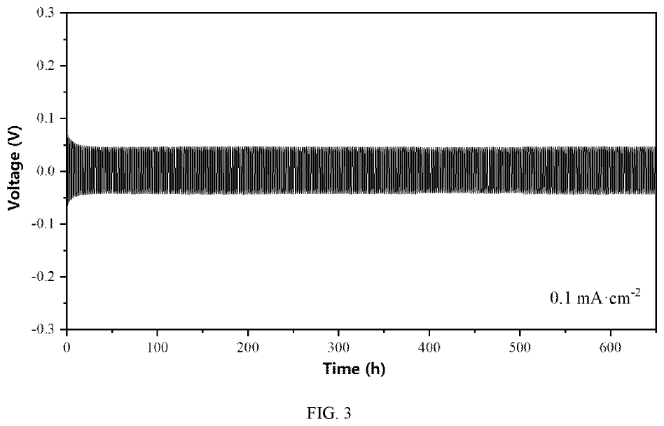

FIG. 3 shows a cycling diagram of Li/interface layer/LATP/interface layer/Li of the lithium symmetric battery containing the interface layer prepared in Embodiment 2 at a current density of 0.1 milliampere per square centimeter (mA/cm⁻²), and it can be seen form the drawing that the constant-current plating/peeling curves of this interface layer of the lithium symmetric battery can be stably cycled for more than 600 h, indicating that this interface layer can effectively impede the contact between lithium metal and LATP while exhibiting a better stability to lithium.

### Embodiment 3

S1, dissolving PVA (93 wt %) and LiFSI (5%) in acetone in an atmosphere filled with argon, and continuously stirring overnight to obtain a uniformly mixed liquid A;

S2, weighing solid electrolyte powder Li_{6.6}La₃Zr_{0.6}Ta_{0.4}O₁₂ (LLZTO) and boron nitride nanoparticles (<150 nm) according to a mass ratio of 1:1 and mixing them evenly, followed by calcining at 600° C. for 6 h after high-energy ball-milling to obtain a mixed powder B; grinding the mixed powder B (2 wt %) and adding it into the mixed liquid A, then continuously mixing and fully stirring after ultrasonic dispersion for 40 min to obtain an interface layer dispersion liquid; and

S3, coating that interface layer dispersion liquid obtained in S2 of the present embodiment onto a surface of a LLZTO ceramic sheet, followed by vacuum drying at 60° C. for 1 h, drying in a blast oven at 80° C. for 6 h, and drying in a vacuum oven at 60° C. for 2 h, then obtaining an interface layer supported by the LLZTO ceramic sheet.

### Embodiment 4

S1, dissolving polyvinylidene fluoride (80 wt %) and LiBOB (10%) in N-Methylpyrrolidone (NMP) solution in an atmosphere filled with argon, and continuously stirring overnight to obtain a uniformly mixed liquid A;

S2, weighing solid electrolyte powder LLZTO and boron nitride nanoparticles (<150 nm) according to a mass ratio of 3:1 and mixing them evenly, followed by calcining at 700° C. for 2 h after high-energy ball-milling to obtain a mixed powder B; grinding the mixed powder B (10 wt %) and adding it into the mixed liquid A, then continuously mixing and fully stirring after ultrasonic dispersion for 40 min to obtain an interface layer dispersion liquid; and

S3, coating that interface layer dispersion liquid obtained in S2 of the present embodiment onto a surface of a LLZTO ceramic sheet, followed by vacuum drying at 60° C. for 1 h, drying in a blast oven at 80° C. for 6 h, and drying in a vacuum oven at 80° C. for 2 h, then obtaining an interface layer supported by the LLZTO ceramic sheet.

### Embodiment 5

S1, dissolving polyvinylidene fluoride-hexafluoropropylene copolymer (60 wt %) and LiDFOB (5%) in DMF solution in an atmosphere filled with argon, and continuously stirring overnight to obtain a uniformly mixed liquid A;

S2, weighing solid electrolyte powder LLZTO and boron nitride nanoparticles (<150 nm) according to a mass ratio of 5:2 and mixing them evenly, followed by calcining at 400° C. for 5 h after high-energy ball-milling to obtain a mixed powder B; grinding the mixed powder B (35 wt %) and adding it into the mixed liquid A, then continuously mixing and fully stirring after ultrasonic dispersion for 40 min to obtain an interface layer dispersion liquid; and

S3, coating that interface layer dispersion liquid obtained in S2 of the present embodiment onto a surface of a LLZTO ceramic sheet, followed by vacuum drying at 70° C. for 1 h, drying in a blast oven at 80° C. for 6 h, and drying in a vacuum oven at 100° C. for 2 h, then obtaining an interface layer supported by the LLZTO ceramic sheet.

According to the present application, the solid electrolyte is coated with the interface layer composed of polymer, lithium salt, boron nitride nanoparticles and mixed powder of solid electrolyte on the surface, where the interface layer has good ionic conductivity and allows lithium ions to selectively pass through; further, boron nitride is added not only to improve the uniform thermal environment at the interface with its good thermal conductivity, promoting the uniform deposition of lithium ions, but also improve the stability of lithium and effectively prevent the penetration of lithium dendrites.

The above embodiments are merely illustrative of the principles of the application and its efficacy, and are not intended to limit the application. Any person skilled in the art may modify or change the above embodiments without violating the spirit and scope of the present application. Therefore, all equivalent modifications or changes made by a person with ordinary knowledge in the art, without departing from the spirit and technical ideas revealed by the present application, shall still fall in the scope of protection defined by the claims of the present application.

What is claimed is:

1. A preparation method of lithium metal and a solid electrolyte interface layer, comprising:
S1, dissolving a polymer matrix in an organic solvent, adding lithium salt and stirring to fully dissolve the lithium salt to obtain a mixed liquid;
S2, ball-milling boron nitride nanoparticles and solid electrolyte powder to obtain a mixed powder, calcining the mixed powder, then uniformly grinding the calcined mixed powder and adding the grinded calcined mixed powder into the mixed liquid obtained in the S1, and fully mixing and stirring after ultrasonic dispersion to obtain an interface layer dispersion liquid; and
S3, coating that interface layer dispersion liquid obtained in the S2 onto a surface of the solid electrolyte, and obtaining an interface layer on the surface of the solid electrolyte after drying.

2. The preparation method of lithium metal and solid electrolyte interface layer according to claim 1, wherein the organic solvent in the S1 is one selected from a group of tetrahydrofuran, propylene carbonate, methyl ethyl carbonate, diethyl carbonate, acetonitrile, acetone, dimethyl sulfoxide, malononitrile, glutaronitrile and N,N-dimethylformamide (DMF).

3. The preparation method of lithium metal and a solid electrolyte interface layer according to claim 1, wherein the polymer matrix in S1 is one selected from a group of polyethylene oxide (PEO), polyvinyl alcohol (PVA), polymethyl methacrylate, polyacrylonitrile and polyvinylidene fluoride; and the polymer matrix accounts for 40-93 percent (%) of a total mass of the interface layer.

4. The preparation method of lithium metal and a solid electrolyte interface layer according to claim 1, wherein the lithium salt in the S1 is one or more selected from a group of lithium bis(trifluoromethanesulphonyl)imide (LiTFSI), lithium bis(fluorosulfonyl)imide (LiFSI), lithium perchlorate (LiClO₄), lithium Hexafluorophosphate (LiPF₆), lithium Tetrafluoroborate (LiBF₄), LiBOB, lithium bis(oxalate)borate (LiDFOB) and lithium difluorophosphate (LiPF₂O₂); and the lithium salt accounts for 5-20% of the total mass of the interface layer.

5. The preparation method of lithium metal and a solid electrolyte interface layer according to claim 1, wherein the boron nitride nanoparticles in the S2 have a particle size of <300 nanometers (nm); and the boron nitride nanoparticles account for 1-20% of the total mass of the interface layer.

6. The preparation method of lithium metal and a solid electrolyte interface layer according to claim 1, wherein the solid electrolyte powder in the S2 is one solid electrolyte of garnet type, perovskite type or NASICON type;
the solid electrolyte powder has a particle size of 1 microns (um)-10 um; and
the solid electrolyte powder accounts for 1-20% of the total mass of the interface layer.

7. The preparation method of lithium metal and a solid electrolyte interface layer according to claim 1, wherein calcining the mixed powder in the S2 is performed at 400-1,000 degree Celsius (° C.).

8. The preparation method of lithium metal and a solid electrolyte interface layer according to claim 1, wherein the interface layer dispersion liquid in the S2 is subjected to vacuum defoaming treatment before coating.

9. The preparation method of lithium metal and a solid electrolyte interface layer according to claim 1, wherein the solid electrolyte used as a coating substrate in the S3 is the solid electrolyte to be modified, and the solid electrolyte is one of garnet type, perovskite type or NASICON type solid electrolytes.

10. An interface layer of metallic lithium and solid electrolyte prepared according to the preparation method in claim 1.
